(19) United States
(12) Patent Application Publication
(10) Pub. No.: US 2011/0123153 A1
(43) Pub. Date: May 26, 2011

(54) ARRAYED WAVEGUIDE GRATING

(75) Inventor: Kazutaka NARA, Tokyo (JP)

(73) Assignee: FURUKAWA ELECTRIC CO., LTD., Tokyo (JP)

(21) Appl. No.: 13/015,218

(22) Filed: Jan. 27, 2011

Related U.S. Application Data
(63) Continuation of application No. PCT/JP09/63330, filed on Jul. 27, 2009.

(30) Foreign Application Priority Data
Jul. 28, 2008 (JP) 2008-193086

(51) Int. Cl. G02B 6/34

(52) U.S. Cl. 385/37

(57) ABSTRACT

An arrayed waveguide grating includes input waveguides, an input slab waveguide, n output waveguides, an output slab waveguide, and an arrayed waveguide. Gaps are formed in the output waveguides other than the output waveguides of both sides of an array of the output waveguides, respectively, such that loss increases toward the central side of the array. Sizes of the gaps in the output waveguides increase toward the central side of the array.

### BACKGROUND OF THE INVENTION

1. Field of the Invention

The present invention relates to an arrayed waveguide grating.

2. Description of the Related Art

In general, in an arrayed waveguide grating (AWG), since strength distribution of diffracted light from an arrayed waveguide is a Gauss function, an envelope of loss in output waveguides also becomes the Gauss function. For this reason, it can be seen that loss is large in waveguides of ends of an array of the output waveguides and loss is small in a central waveguide of the array.

In order to improve loss uniformity, a method that increases a free spectral range (FSR) of the AWG is generally used. However, if the FSR increases, a circuit size increases. As a result, there is a limitation in the increase amount of the FSR.

Meanwhile, as a method that improves loss uniformity without greatly increasing the FSR as described above, a method that changes the width of a fiber connection portion is suggested, as disclosed in “Engineering study magazine, Hitachi Cable (2000.1, No. 19).

However, in the related art that is disclosed in “Engineering study magazine, Hitachi Cable (2000.1, No19)”, production error occurs at the time of fiber connection and there is a problem from a point of view of stable production.

### SUMMARY OF THE INVENTION

The present invention has been made in views of the above-described problems, and it is an object of the present invention to provide an arrayed waveguide grating in which a circuit size is not increased, a manufacturing influence is small, and loss uniformity is improved.

In order to resolve the above problems, an arrayed waveguide grating according to an aspect of the present invention includes at least one input waveguide; an input slab waveguide that is connected to the input waveguide; plural output waveguides; an output slab waveguide that is connected to the output waveguides; and an arrayed waveguide that is connected between the input slab waveguide and the output slab waveguide. Gaps are formed in the output waveguides other than at least the output waveguides of both sides of an array of the plural output waveguides, respectively, such that loss increases toward the central side of the array.

According to this configuration, loss uniformity of the plural output waveguides is improved. Since this method is not the method that improves the loss uniformity by increasing a free spectral range (FSR), a circuit size does not increase. Since the gaps can be easily formed using a semiconductor fine processing technology (photolithography), a manufacturing influence is small.

In an arrayed waveguide grating according to another aspect of the present invention, sizes of the gaps are different from each other in the output waveguides other than at least the output waveguides of both sides of the array. According to this configuration, loss uniformity of the plural output waveguides is improved.

In an arrayed waveguide grating according to another aspect of the present invention, sizes of the gaps increase toward the central side of the array, in the output waveguides other than at least the output waveguides of both sides of the array. According to this configuration, loss increases toward the central side of the array. As a result, loss uniformity of the plural output waveguides is improved.

In an arrayed waveguide grating according to another aspect of the present invention, sizes of the gaps in the output waveguides other than at least the output waveguides of both sides of the array are equal to each other, an end of an emission-side waveguide portion that exists at the side of the output slab waveguide of two waveguide portions of the individual output waveguides facing each other through the gaps, is formed with a tapered end where the core width of the emission-side waveguide portion gradually decreases toward the end side of the waveguide portion, and a mode field diameter of the tapered end is smaller than a mode field diameter of the another waveguide portion facing to the tapered end and decreases toward the central side of the array.

According to this configuration, a mode field diameter of the end of the emission-side waveguide portion that exists at the side of the output slab waveguide of the two waveguide portions of the individual output waveguides facing each other through the gaps is decreased toward the central side of the array. Therefore, as the output waveguides come close to the central side, a diffusion angle based on diffraction increases and loss increases. As a result, loss uniformity of the plural output waveguides is improved.

In an arrayed waveguide grating according to another aspect of the present invention, a mode field diameter of an end of an emission-side waveguide portion that exists at the side of the output slab waveguide of two waveguide portions of the individual output waveguides facing each other through the gaps decreases toward the central side of the array.

According to this configuration, the sizes of the gaps of the output waveguides other than the output waveguides of both sides of the array are increased toward the central side of the array, and a mode field diameter of the end of the emission-side waveguide portion in the two waveguide portions of the individual output waveguides facing each other through the gaps is set to decrease toward the central side of the array. By this combination, loss uniformity of the plural output waveguides is further improved.

In an arrayed waveguide grating according to another aspect of the present invention, sizes of the gaps in the output waveguides other than at least the output waveguides of both sides of the array are equal to each other, an end of an emission-side waveguide portion that exists at the side of the output slab waveguide of two waveguide portions of the individual output waveguides facing each other through the gaps, is formed with a tapered end where the core width of the emission-side waveguide portion gradually increases toward the end side of the waveguide portion, and a mode field diameter of the tapered end is larger than a mode field diameter of the another waveguide portion facing to the tapered end and increases toward the outside of the array.

According to this configuration, as the output waveguides come close to the outside, a diffusion angle based on diffraction decreases and loss decreases. As a result, loss uniformity of the plural output waveguides is improved.

According to the present invention, an arrayed waveguide grating in which a circuit size is not increased, a manufacturing influence is small, and loss uniformity is improved can be provided.

### BRIEF DESCRIPTION OF THE DRAWINGS

FIG. 1A is a plan view illustrating an arrayed waveguide grating according to an embodiment of the present invention;

FIG. 1B is an enlarged view of an X portion of FIG. 1A;

FIG. 2 is a graph illustrating a relationship between an output waveguide number (channel number) and a loss variation in each channel;

FIG. 3 is a graph illustrating a relationship between a gap (waveguide gap) and loss;

FIG. 4 is a graph illustrating loss uniformity that is obtained by an arrayed waveguide plating 10 according to the embodiment of the present invention and loss uniformity that is obtained in the related art;

FIG. 5 is a plan view illustrating a main portion of a modification of the embodiment; and

FIG. 6 is a plan view illustrating a main portion of another modification of the embodiment.

### DETAILED DESCRIPTION OF THE PREFERRED EMBODIMENTS

Next, an exemplary embodiment of the present invention will be described on the basis of the drawings.

### Embodiment

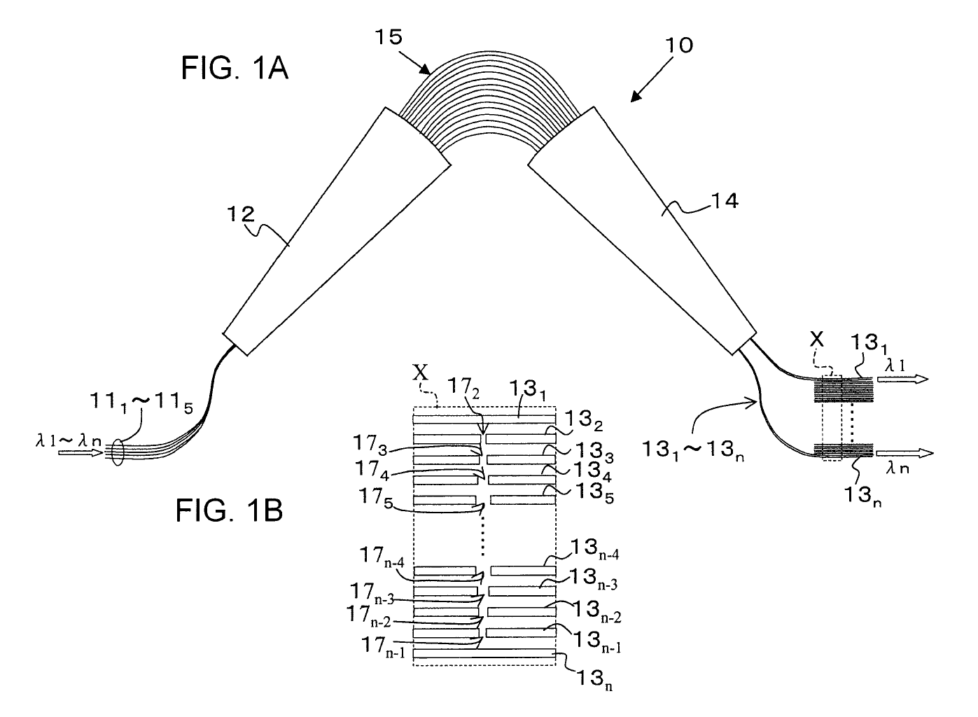

FIG. 1A illustrates the schematic configuration of an arrayed waveguide grating according to an exemplary embodiment of the present invention. FIG. 1B is an enlarged view of an X portion of FIG. 1A.

As shown in FIG. 1A, an arrayed waveguide grating 10 is planar lightwave circuit (PLC) where an optical waveguide composed of a core and a clad is produced on a substrate (not shown in the drawings), such as a quartz substrate or a silicon substrate, using an optical fiber producing technology and a semiconductor fine processing technology.

The arrayed waveguide grating 10 comprises five input waveguides 11₁ to 11₅, an input slab waveguide 12 that is connected to the input waveguides 11₁ to 11₅, plural (n) output waveguides 13₁ to 13ₙ, an output slab waveguide 14 that is connected to the output waveguides, and an arrayed waveguide 15 that is connected between the input slab waveguide 12 and the output slab waveguide 14. The number of input waveguides is not limited to five and may be at least one.

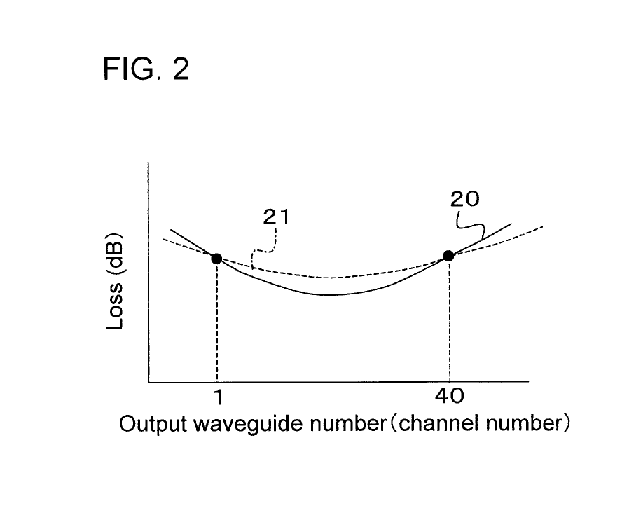

A loss variation in individual channels described above, that is, a loss variation between the individual output waveguides 13₁ to 13ₙ of output waveguide numbers 1 to n (channel numbers 1ch to nch) is small in a central portion of an array of the output waveguides and is large in ends of the array, as shown by a curved line 20 of FIG. 2. Accordingly, in a normal case, it is considered that the loss of the ends of the array is decreased without changing the loss of the central portion of the array.

However, in the arrayed waveguide grating 10 according to this embodiment, the loss of the ends, that is, the loss of the output waveguides 13₁ and 13ₙ of both sides of the array is not changed, the loss of the output waveguides that are close to the central side of the array is increased to be adapted to the loss in the output waveguides 13₁ and 13ₙ, thereby the loss variation is decreased, and loss uniformity is improved. That is, the entire loss variation is made to be uniform to be adapted to the output waveguides 13₁ and 13ₙ of both sides having the large loss.

For this reason, as shown in FIG. 1B, in the arrayed waveguide grating 10, gaps 17₂ to 17ₙ₋₁ are formed in the output waveguides 13₂ to 13ₙ₋₁ other than the output waveguides 13₁ and 13ₙ of both sides of the array of the n output waveguides 13₁ to 13ₙ, respectively, such that the loss increases toward the central side of the array.

Specifically, sizes of the gaps 17₂ to 17ₙ₋₁ increase toward the central side of the array, in the output waveguides 13₂ to 13ₙ₋₁ other than the output waveguides 13₁ and 13ₙ of both sides of the array.

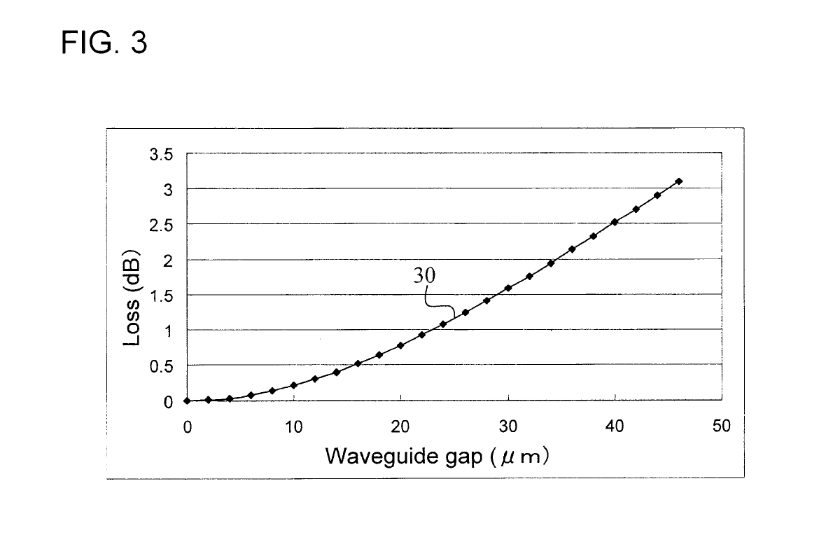

A relationship between the gaps (waveguide gaps) provided in the output waveguides 13₂ to 13ₙ₋₁ and the loss is shown in FIG. 3. It can be seen from a curved line 30 of FIG. 3 that the loss increases as the sizes of the gaps (waveguide gaps) provided in the output waveguides 13₂ to 13ₙ₋₁ increase.

In the arrayed waveguide grating 10, if optical signals λ1 to λn where plural optical signals having different wavelengths are multiplexed are input to the central input waveguide 11₃ of the input waveguides 11₁ to 11₅, the optical signals λ1 to λn are diffused by diffraction in the input slab waveguide 12 and are input to the arrayed waveguide 15. Since the lengths of the individual waveguides of the arrayed waveguide 15 are different from each other by ΔL, a phase difference that depends on the wavelength is generated in an output end of the arrayed waveguide 15. In the output slab waveguide 14, since light of the individual wavelengths where the same phase condition is realized by multiple interference (strengthened mutually) is coupled with the corresponding output waveguides 13₁ to 13ₙ, demultiplexing (DEMUX) is made.

According to the embodiment that has the above configuration, the following function and effect are achieved. As described above, the gaps 17₂ to 17ₙ₋₁ are formed in the output waveguides 13₂ to 13ₙ₋₁ other than the output waveguides 13₁ and 13ₙ of both sides of the array of the n output waveguides 13₁ to 13ₙ, respectively. The sizes of the gaps 17₂ to 17ₙ₋₁ increase toward the central side of the array, in the output waveguides 13₂ to 13ₙ₋₁ other than the output waveguides 13₁ and 13ₙ of both sides of the array. Thereby, the loss increases toward the central side of the array. As a result, as shown by a curved line 21 of FIG. 2, loss uniformity of the n output waveguides 13₁ to 13ₙ is improved.

Since this method is not the method that improves the loss uniformity by increasing the free spectral range (FSR) of the arrayed waveguide grating 10, the circuit size does not increase.

Since the gaps 17₂ to 17ₙ₋₁ can be easily formed in the output waveguides 13₂ to 13ₙ₋₁ other than the output waveguides 13₁ and 13ₙ of both sides of the array of the n output waveguides 13₁ to 13ₙ using a semiconductor fine processing technology (photolithography), a manufacturing influence is small.

### Example

As an example, an arrayed waveguide grating 10 (100 GHz and 40ch) where a refractive index contrast Δ is 0.8% and a core size is 6×6 μm² is produced. Accordingly, the number of plural (n) output waveguides 13₁ to 13ₙ is n=40. In the arrayed waveguide grating 10, the FRS is set to about 6500 GHz. In Table 1 described below, the sizes of the gaps in the output waveguides 13₁ to 13ₙ (1ch to 40ch) are shown. As shown in Table 1, the sizes of the gaps are different from each other in the output waveguides 13₂ to 13ₙ₋₁ other than the output waveguides 13₁ and 13ₙ of both sides of the array.

TABLE 1

| | Gap size |
|---|---|
| 1ch | 0.000 |
| 2ch | 8.007 |
| 3ch | 11.089 |
| 4ch | 13.328 |
| 5ch | 15.111 |
| 6ch | 16.586 |
| 7ch | 17.830 |
| 8ch | 18.887 |
| 9ch | 19.787 |
| 10ch | 20.553 |
| 11ch | 21.200 |
| 12ch | 21.741 |
| 13ch | 22.187 |
| 14ch | 22.548 |
| 15ch | 22.831 |
| 16ch | 23.045 |
| 17ch | 23.198 |
| 18ch | 23.296 |
| 19ch | 23.350 |
| 20ch | 23.370 |
| 21ch | 23.370 |
| 22ch | 23.350 |
| 23ch | 23.297 |
| 24ch | 23.198 |
| 25ch | 23.045 |
| 26ch | 22.831 |
| 27ch | 22.548 |
| 28ch | 22.187 |
| 29ch | 21.741 |
| 30ch | 21.200 |
| 31ch | 20.553 |
| 32ch | 19.788 |
| 33ch | 18.887 |
| 34ch | 17.830 |
| 35ch | 16.587 |
| 36ch | 15.111 |
| 37ch | 13.328 |
| 38ch | 11.089 |
| 39ch | 8.007 |
| 40ch | 0.000 |

(Unit: μm)

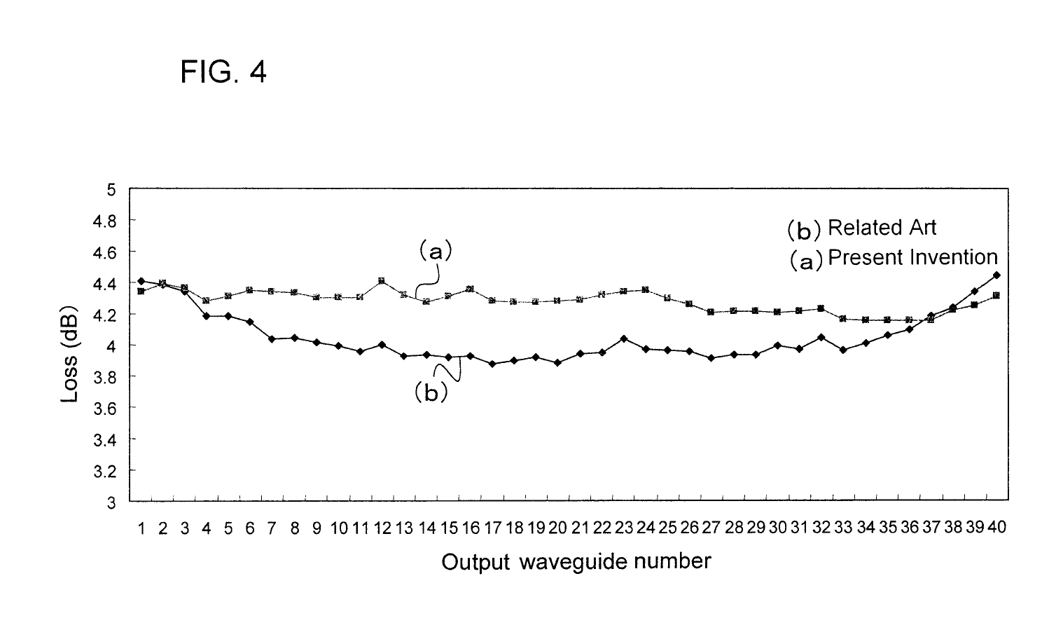

By the arrayed waveguide grating 10 according to this example, the loss uniformity that was 0.7 dB as shown by a curved line (b) of FIG. 4 is greatly improved to 0.25 dB as shown by a curved line (a) of FIG. 4.

The present invention can be changed as follows and specified.

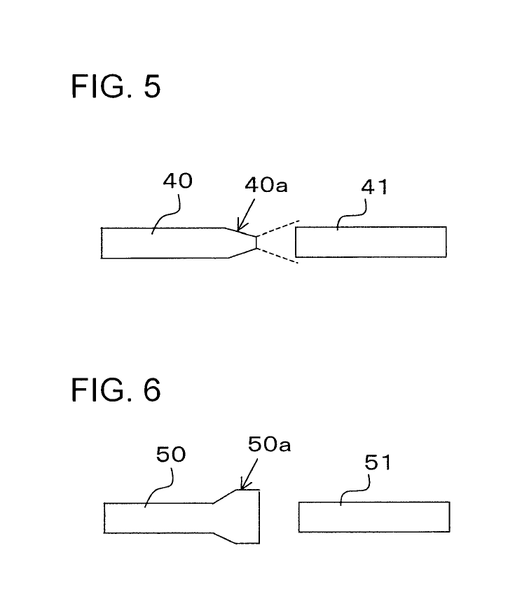

In the above embodiment, the sizes of the gaps 17₂ to 17ₙ₋₁ that are formed in the output waveguides 13₂ to 13ₙ₋₁ other than the output waveguides 13₁ and 13ₙ of both sides of the array of the n output waveguides 13₁ to 13ₙ increase toward the central side of the array, but the present invention is not limited thereto. For example, the sizes of the gaps that are formed in the output waveguides 13₂ to 13ₙ₋₁ other than the output waveguides 13₁ and 13ₙ of both sides of the array are set to the same size. In this case, in two waveguide portions 40 and 41 (refer to FIG. 5) of the individual output waveguides 13₂ to 13ₙ₋₁ facing each other through the gaps, in an end of the emission-side waveguide portion 40 that exists at the side of the output slab waveguide 14, a tapered end 40a (refer to FIG. 5) where the core width of the emission-side waveguide portion 40 gradually decreases toward the end side thereof is formed. In addition, the mode field diameter of the tapered end 40a may be set to be smaller than the mode field diameter of the waveguide portion 41 and may be set to decrease toward the central side of the array. According to this configuration, as the output waveguides come close to the central side, a diffusion angle based on diffraction increases and loss increases. As a result, loss uniformity of the n output waveguides 13₁ to 13ₙ is improved.

In the embodiment, in the two waveguide portions 40 and 41 (refer to FIG. 5) of the individual output waveguides 13₂ to 13ₙ₋₁ facing each other through the gaps, in the end of the emission-side waveguide portion 40 that exists at the side of the output slab waveguide 14, the tapered end 40a (refer to FIG. 5) may be formed, and the mode field diameter of the tapered end 40a may be set to decrease toward the central side of the array. According to this configuration, the sizes of the gaps of the output waveguides 13₂ to 13ₙ₋₁ are increased toward the central side of the array, and the mode field diameter of the tapered end 40a of the emission-side waveguide portion 40 is set to decrease toward the central side of the array, of the two waveguide portions 40 and 41 of the individual output waveguides 13₂ to 13ₙ₋₁ facing each other through the gaps. By this combination, the loss uniformity of the plural output waveguides is further improved.

In the embodiment, the sizes of the gaps of the output waveguides 13₂ to 13ₙ₋₁ other than the output waveguides 13₁ and 13ₙ of both sides of the array may be set to the same size. In this case, in two waveguide portions 50 and 51 (refer to FIG. 6) of the individual output waveguides 13₂ to 13ₙ₋₁ facing each other through the gaps, in an end of the emission-side waveguide portion 50 that exists at the side of the output slab waveguide 14, a tapered end 50a (refer to FIG. 6) where the core width of the emission-side waveguide portion 50 gradually increases toward the end side thereof is formed. In addition, the mode field diameter of the tapered end 50a may be set to be larger than the mode field diameter of the waveguide portion 51 and may be set to increase toward the outside of the array. According to this configuration, as the output waveguides come close to the outside, a diffusion angle based on diffraction decreases and loss decreases. As a result, loss uniformity of the n output waveguides 13₁ to 13ₙ is improved.

In the above embodiment, the arrayed waveguide grating 10 that includes the five input waveguides 11₁ to 11₅ is exemplified, but the number of input waveguides is not limited to five. That is, the present invention can be applied to an arrayed waveguide grating that includes at least one input waveguide.

What is claimed is:

1. An arrayed waveguide grating, comprising:
at least one input waveguide;
an input slab waveguide that is connected to the input waveguide;
a plurality of output waveguides;
an output slab waveguide that is connected to the output waveguides; and
an arrayed waveguide that is connected between the input slab waveguide and the output slab waveguide,
wherein gaps are formed in the output waveguides other than at least the output waveguides of both sides of an array of the plurality of output waveguides, respectively, such that loss increases toward the central side of the array.

2. The arrayed waveguide grating of claim 1,
wherein sizes of the gaps are different from each other in the output waveguides other than at least the output waveguides of both sides of the array.

3. The arrayed waveguide grating of claim 1,
wherein sizes of the gaps increase toward the central side of the array, in the output waveguides other than at least the output waveguides of both sides of the array.

4. The arrayed waveguide grating of claim 1,
wherein sizes of the gaps in the output waveguides other than at least the output waveguides of both sides of the array are equal to each other,
an end of an emission-side waveguide portion that exists at the side of the output slab waveguide of two waveguide portions of the individual output waveguides facing each other through the gaps, is formed with a tapered end where the core width of the emission-side waveguide portion gradually decreases toward the end side of the waveguide portion, and
a mode field diameter of the tapered end is smaller than a mode field diameter of the another waveguide portion facing to the tapered end and decreases toward the central side of the array.

5. The arrayed waveguide grating of claim 3,
wherein a mode field diameter of an end of an emission-side waveguide portion that exists at the side of the output slab waveguide of two waveguide portions of the individual output waveguides facing each other through the gaps decreases toward the central side of the array.

6. The arrayed waveguide grating of claim 1,
wherein sizes of the gaps in the output waveguides other than at least the output waveguides of both sides of the array are equal to each other,
an end of an emission-side waveguide portion that exists at the side of the output slab waveguide of two waveguide portions of the individual output waveguides facing each other through the gaps, is formed with a tapered end where the core width of the emission-side waveguide portion gradually increases toward the end side of the waveguide portion, and
a mode field diameter of the tapered end is larger than a mode field diameter of the another waveguide portion facing to the tapered end and increases toward the outside of the array.
